(19) United States
(12) Patent Application Publication
(10) Pub. No.: US 2010/0015850 A1
(43) Pub. Date: Jan. 21, 2010

(54) LOW-PROFILE MOUNTED PUSH-ON CONNECTOR

(76) Inventor: Casey Roy Stein, Surprise, AZ (US)

Correspondence Address: CORNING INCORPORATED, SP-TI-3-1, CORNING, NY, 14831, US

(21) Appl. No.: 12/501,810

(22) Filed: Jul. 13, 2009

Related U.S. Application Data
(60) Provisional application No. 61/080,784, filed on Jul. 15, 2008.

(51) Int. Cl. H01R 9/05

(52) U.S. Cl. 439/581

(57) ABSTRACT

An electrical connector has an outer shroud and a center conductor. The outer shroud has an opening with a first diameter in a center portion of the outer shroud and a second diameter adjacent a second end thereof, the first diameter being smaller than the second diameter. The outer shroud also has a first end providing a physical stop for a female connector that mates with the electrical connector. The female connector has a distal end of an outer conductor that does not engage the outer shroud of the electrical connector.

### CROSS-REFERENCE To RELATED APPLICATIONS

This application claims the benefit of, and priority to U.S. Provisional Patent Application No. 61/080,784 filed on Jul. 15, 2008 entitled, “Low-Profile Mounted Push-On Connector”, the content of which is relied upon and incorporated herein by reference in its entirety.

### BACKGROUND OF THE INVENTION

1. Field of the Invention

The present invention relates generally to low-profile push-on RF connectors, and particularly to low-profile PCB-mounted push-on RF connectors that do not require standard reference planes for manufacturing.

2. Technical Background

Coaxial connectors used to transmit radio frequency signals for broadband telecommunications, military avionics, and microwave systems are well known in the art. Such connectors are often known as “SMP” connectors, or “SMPM” connectors, and are constructed in accordance with military standard MILSTD 348. For example, for many years, Gilbert Engineering Co., Inc. of Glendale, Ariz., now Corning Gilbert Inc., has made available microwave coaxial connectors sold under the trademarks “GPO,” “GPPO” and “G3PO” to facilitate so-called “push-on” connectors in microwave applications. Such connectors are typically designed to handle signals in the frequency range from approximately 2 GHz up to as much as 100 GHz.

Prior coaxial connectors used on PC boards are generally too large to allow for soldering and to allow for adequate spacing on the PC board. However, as electronics have become more compact, more compact connectors are needed. Additionally, prior art connectors have been designed around a reference plane, with the connector dimensions measured from the reference plane. Eliminating the reference plane, typically on the interior of the connectors, allows electrical connectors to be designed that function better in the smaller environments.

It would be desirable therefore to provide an electrical connector that can be used in small spaces, on PC boards that were designed for larger connectors, and without having to worry about reference planes that heretofore dictated manufacturing specifications.

### SUMMARY OF THE INVENTION

Disclosed herein is an electrical connector that includes a shroud having a first end, a second end, and an opening extending between the first end and the second end, the opening having a first diameter in a center portion of the shroud and a second diameter adjacent the second end, the first diameter being smaller than the second diameter, and a center conductor disposed so that at least a portion of the center conductor extends into the opening from the second end of the shroud.

In some embodiments, the electrical connector is mounted on a circuit board.

In some embodiments, the shroud engages a body portion of a female connector, providing a mechanical stop.

In some embodiments, the circuit board has a solder pad in electrical communication with the center conductor and the shroud and the solder pad are at a distance from one another that is less than the diameter of the solder pad.

In another aspect, an electrical connector is disclosed that includes a shroud having a first end, a second end, and an opening extending between the first end and the second end, the opening having a first diameter in a center portion of the shroud and a second diameter adjacent the second end, the first diameter being smaller than the second diameter, and the second end being mechanically and electrically connected to a first portion of a circuit board, and a center conductor mechanically and electrically connected to a second portion of a circuit board and disposed so that at least a portion of the center conductor extends into the opening of the shroud from the second end thereof.

In yet another aspect, the invention is directed to a pair of push-on RF connectors for use with a circuit board that includes a first connector, the first connector having a male configuration, the first connector includes a shroud having a first end, a second end, and an opening extending between the first end and the second end, the opening having a first diameter in a center portion of the shroud and a second diameter adjacent the second end, the first diameter being smaller than the second diameter and a center conductor disposed so that at least a portion of the center conductor extends into the opening from the second end of the shroud, and a second connector, the second connector having a female configuration that includes a body, the body having a forward facing shoulder, an outer conductor, the outer conductor having a radially outward surface configured to engage an inner surface in the opening of the shroud, and an inner conductor, the inner conductor mechanically and electrically engaging the center conductor, wherein the shroud engages only the body and the radially outward surface of the outer conductor.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description present embodiments of the invention, and are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention, and together with the description serve to explain the principles and operations of the invention.

### BRIEF DESCRIPTION OF THE DRAWINGS

FIG. 1 is a partial cross sectional view of prior art electrical connectors in a mated position;

FIG. 2 is a cross sectional view of a prior art male electrical connector;

FIG. 3 is a partial cutaway view of a prior art female connector;

FIG. 4 is an enlarged view of the electrical connectors of FIG. 1 where the male and female connectors engage one another;

FIG. 5 is a partial cross sectional view of one embodiment of electrical connectors in a mated position according to the present invention;

FIG. 6 is a cross sectional view of the male electrical connector of FIG. 5;

FIG. 7 is a cross-sectional view of the female electrical connector of FIG. 5; and

FIG. 8 an enlarged view of the electrical connectors of FIG. 5 where the male and female connectors engage one another.

### DETAILED DESCRIPTION OF THE PREFERRED EMBODIMENTS

Reference will now be made in detail to the present preferred embodiment(s) of the invention, examples of which are illustrated in the accompanying drawings. Whenever possible, the same reference numerals will be used throughout the drawings to refer to the same or like parts.

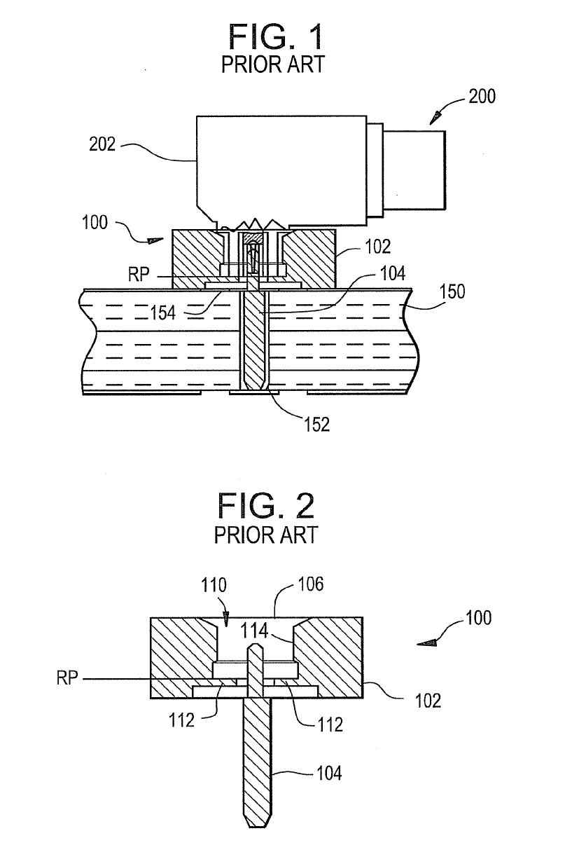

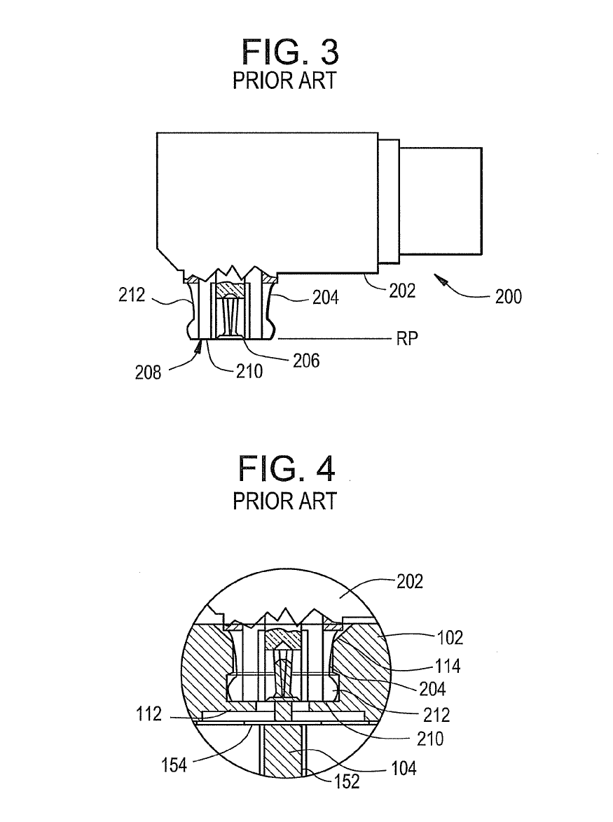

Referring to FIGS. 1-4, a prior art male electrical connector 100, mounted on a PC board 150, is illustrated as being electrically and mechanically connected to a prior art female electrical connector 200. The male electrical connector 100 illustrated in more detail in FIG. 2 includes an outer shroud 102 and a center conductor 104. The outer shroud 102 and center conductor 104 are typically independent elements, but operate as the male connector. The center conductor 104 is disposed in an opening 152 in the PC board 150 and is soldered to physically retain the center conductor 104 in the opening 152 and also to electrically connect the center conductor 104 to the solder pad 154 adjacent the opening 152. Preferably, the outer shroud 102 has a first end 106 and a second end 108, with an opening 110 extending therebetween. The opening 110 has an enlarged diameter at the first end 106 to receive the female electrical connector 200. The second end 108 of the outer shroud 102 has a large diameter recessed portion immediately adjacent thereto, allowing for connection of the second end 108 to solder pad 154 on the PC board 150 without the second end 108 of outer shroud 102 also making electrical contact with the solder pad 154. Outer shroud 102 also has an inwardly projecting web portion 112 adjacent to the second end 108, which provides a mechanical stop for the female connector 200, as noted in more detail below. The web portion 112 projects radially inward from the wall surface 114 of the outer shroud 102 such that the web portion 112 overhangs the solder pad 154 on the PC board 150. See FIG. 4. When soldering the center conductor 104 to the PC board 150, solder can accumulate on the solder pad 154 and cause arcing between the solder pad 154 and the outer shroud 102, shorting out the connector.

The female electrical connector 200 has an outer body 202, an outer conductor 204, and an inner conductor 206. The female electrical connector 200 is attached to a coaxial cable, not shown. The inner conductor 206 is configured to receive the center conductor 104 to mechanically and electrically connect the male electrical connector and the female electrical connector. The outer conductor 204 has a distal end 208 with a forward facing surface 210 and a radially outward facing surface 212. The distal end 208 physically and electrically engages the web portion 112 of the outer shroud 102, presenting a reference plane RP from which the dimensions of the male electrical connector 100 and female electrical connector 200 are measured. The radially outward facing surface 212 also engages the wall surface 114 to assist in securing the female electrical connector 200 to the male electrical connector 100. It should be noted that the outer body 202 does not engage the outer shroud 102.

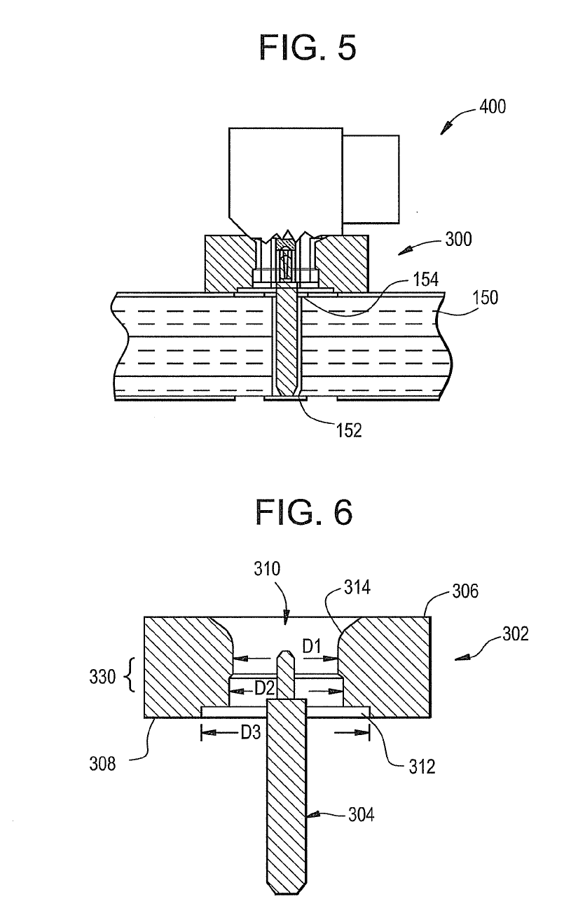

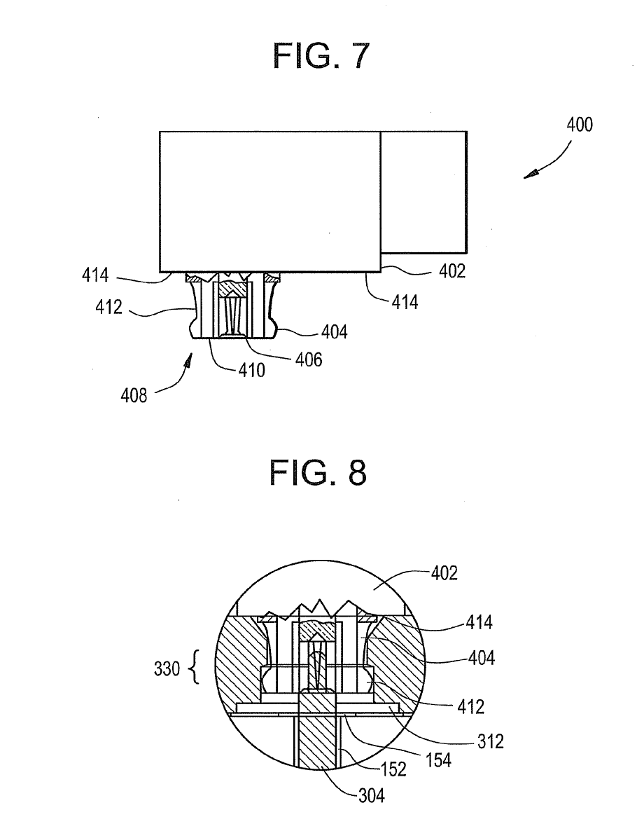

A pair of electrical connectors according to one embodiment of the present invention are illustrated in FIGS. 5-8. One embodiment of a male electrical connector 300 according to the present invention, mounted on a PC board 150, is illustrated as being electrically and mechanically connected to one embodiment of a female electrical connector 400 according to the present invention. The male electrical connector 300, illustrated in more detail in FIG. 6, includes an outer shroud 302 and a center conductor 304. The outer shroud 302 and center conductor 304 are typically independent elements, but operate as the male electrical connector. The center conductor 304 is preferably made from brass or beryllium copper with gold over a nickel plating. The outer shroud 302 is preferably made from the same materials, but may also be made using passivated stainless steel or a nickel-cobalt ferrous alloy such as Kovar. The center conductor 304 is disposed in an opening 152 in the PC board 150 and is soldered to physically retain the center conductor 304 in the opening 152 and also to electrically connect the center conductor 304 to the solder pad 154 adjacent the opening 152. Preferably, the outer shroud 302 has a first end 306 and a second end 308, with an opening 310 extending therebetween. The opening 310 has a wall surface 314 and an enlarged diameter at the first end 306 to receive the female electrical connector 400. The second end 308 of the outer shroud 302 has a large diameter recessed portion 312 immediately adjacent thereto, allowing for connection of the second end 308 to solder pad 154 on the PC board 150 without the second end 308 of outer shroud 302 also making electrical contact with the solder pad 154. The opening 310 of outer shroud 302 has a center portion 330 that has a generally consistent diameter D1 that is smaller than the diameter D2 of the opening 310 closer to the second end 308. As noted above, the opening 310 then has a diameter D3 immediately adjacent the second end 308 that is larger than either D1 or D2. Outer shroud 310 does not include the web portion of the prior art device. The opening 310 adjacent the first end 306 also preferably slopes inward more gradually toward the center portion 330. The opening 310 adjacent the second end 308 generally corresponds to the profile of the center conductor 304, as best seen in FIG. 6.

The female electrical connector 400 has an outer body 402, an outer conductor 404, and an inner conductor 406. The inner conductor 406 is configured to receive the center conductor 304 to mechanically and electrically connect the male electrical connector and the female electrical connector. The outer conductor 404 has a distal end 408 with a forward facing surface 410 and a radially outward facing surface 412. The radially outward facing surface 412 physically and electrically engages the wall surface 314 of the opening 310 of the outer shroud 302. However, it is a forward facing surface 414 of the outer body 402 that engages the first end 306 of the outer shroud 302 to provide a mechanical stop for the female electrical connector 400 relative to the male electrical connector 300. As such, the distal end 408 of the outer conductor 404 does not engage any portion of the outer shroud 302. The female electrical connector 400 is preferably made from the same materials as note above with respect to the male electrical connector 300.

As best seen in FIG. 8, the smallest diameter of opening 310 (D1 in the center portion 330) is larger than the diameter of the solder pad 154, eliminating the possibility of solder from soldering the center conductor 304 into the PC board 150 reaching the outer shroud 302 and shorting out the connector. While the drawings are not necessarily drawn to scale, the distance between the solder pad 154 and the closest portion of the outer shroud 302 (typically a portion of the wall surface 314) is less than the diameter of the solder pad 154. Applicants note that it is possible to have the distance between the outer shroud 302 and the solder pad 154 larger than the diameter of the solder pad 154, but such a configuration prevents the use of the electrical connectors 300,400 from being used in a small, confined space as are the connectors according to the present invention.

It will be apparent to those skilled in the art that various modifications and variations can be made to the present invention without departing from the spirit and scope of the invention. Thus it is intended that the present invention cover the modifications and variations of this invention provided they come within the scope of the appended claims and their equivalents.

What is claimed is:

1. An electrical connector comprising:
a shroud having a first end, a second end, and an opening extending between the first end and the second end, the opening having a first diameter in a center portion of the shroud and a second diameter adjacent the second end, the first diameter being smaller than the second diameter; and
a center conductor disposed so that at least a portion of the center conductor extends into the opening from the second end of the shroud.

2. The electrical connector according to claim 1, wherein the center conductor and the shroud are in mechanical and electrical contact with a circuit board.

3. The electrical connector according to claim 1, wherein the first end of the shroud has an outer surface, the outer surface comprising a mechanical stop for a cooperating female electrical connector.

4. The electrical connector according to claim 1, wherein the shroud opening adjacent the second end of the shroud generally corresponds to a profile of the center conductor.

5. The electrical connector according to claim 1, wherein the center conductor is mechanically and electrically engaged with a center conductor of a female connector,
wherein the shroud is mechanically and electrically engaged with an outer conductor of the female connector; and
wherein a distal end of the outer conductor of the female connector has a forward facing surface, the forward facing surface does not engage any portion of the shroud.

6. The electrical connector according to claim 5, wherein the first end of the shroud engages a body of the female electrical connector when the electrical connector and the female electrical connector are fully mated.

7. The electrical connector according to claim 2, wherein the center conductor is disposed in an opening in the circuit board, the circuit board having a solder pad on a surface thereof adjacent the shroud opening, the solder pad being in electrical communication with the center conductor and having a pad diameter, the pad diameter being smaller than the second diameter of the shroud, and wherein the solder pad and shroud are at a distance from one another that is less than the pad diameter.

8. An electrical connector comprising:
a shroud having a first end, a second end, and an opening extending between the first end and the second end, the opening having a first diameter in a center portion of the shroud and a second diameter adjacent the second end, the first diameter being smaller than the second diameter, and the second end being mechanically and electrically connected to a first portion of a circuit board; and
a center conductor mechanically and electrically connected to a second portion of a circuit board and disposed so that at least a portion of the center conductor extends into the opening of the shroud from the second end thereof.

9. The electrical connector according to claim 8, wherein the first end of the shroud has an outer surface, the outer surface comprising a mechanical stop for a cooperating female electrical connector.

10. The electrical connector according to claim 8, wherein the shroud opening adjacent the second end of the shroud generally corresponds to a profile of the center conductor.

11. The electrical connector according to claim 8, wherein the center conductor is mechanically and electrically engaged with a center conductor of a female connector,
wherein the shroud is mechanically and electrically engaged with an outer conductor of the female connector; and
wherein a distal-end of the outer conductor of the female connector has a forward facing surface, the forward facing surface does not engage any portion of the shroud.

12. A pair of push-on RF connectors for use with a circuit board comprising:
a first connector, the first connector having a male configuration and comprising:
a shroud having a first end, a second end, and an opening extending between the first end and the second end, the opening having a first diameter in a center portion of the shroud and a second diameter adjacent the second end, the first diameter being smaller than the second diameter; and
a center conductor disposed so that at least a portion of the center conductor extends into the opening from the second end of the shroud; and
a second connector, the second connector having a female configuration and comprising:
a body, the body having a forward facing shoulder;
an outer conductor, the outer conductor having a radially outward surface configured to engage an inner surface in the opening of the shroud; and
an inner conductor, the inner conductor mechanically and electrically engaging the center conductor;
wherein the shroud engages only the body and the radially outward surface of the outer conductor.

13. The electrical connector according to claim 12, wherein the first end of the shroud has an outer surface, the outer surface comprising a mechanical stop for the second connector.

14. The electrical connector according to claim 12, wherein the shroud opening adjacent the second end of the shroud generally corresponds to a profile of the center conductor.

15. The electrical connector according to claim 12, wherein the center conductor of the first connector is mechanically and electrically engaged with the inner conductor of the second connector,
wherein the shroud is mechanically and electrically engaged with the outer conductor of the second connector; and
wherein a distal end of the outer conductor of the female connector has a forward facing surface, the forward facing surface does not engage any portion of the shroud.

16. The electrical connector according to claim 12, wherein the center conductor is disposed in an opening in the circuit board, the circuit board having a solder pad on a surface thereof adjacent the shroud opening, the solder pad being in electrical communication with the center conductor and having a pad diameter, the pad diameter being smaller than the second diameter of shroud and wherein the solder pad and shroud are at a distance from one another that is less than the pad diameter.
